(19) United States
(12) Patent Application Publication
(10) Pub. No.: US 2014/0207461 A1
(43) Pub. Date: Jul. 24, 2014

(54) CAR A/V SYSTEM WITH TEXT MESSAGE VOICE OUTPUT FUNCTION

(71) Applicant: Shih-Yao CHEN, New Taipei City (TW)

(72) Inventor: Shih-Yao CHEN, New Taipei City (TW)

(21) Appl. No.: 13/749,338

(22) Filed: Jan. 24, 2013

(51) Int. Cl. G10L 13/08

(52) U.S. Cl. CPC G10L 13/08
USPC 704/260

(57) ABSTRACT

A car A/V system head unit includes a text message receiving and decoding device for receiving a text message sent by an external communication device and decoding the text message into a decoded data signal, a display device including a display zone for display the decoded data signal and function selection touch zones selectively touchable by a person to select different functions, a text/voice converter for converting the decoded data signal into a voice signal, and a voice output system for outputting the voice signal. Thus, the car A/V system head unit can convert each received text message into a voice signal and output the voice signal directly in the car, avoiding distracted driving and enhancing driver safety.

### BACKGROUND OF THE INVENTION

1. Field of the Invention

The present invention relates to car A/V systems and more particularly, to a car A/V system with text message voice output function, which converts every received text message into a voice signal for output when the user is driving the car, avoiding distracted driving and enhancing driver safety.

2. Description of the Related Art

A car generally has an A/V (audio/video) system head unit installed therein for audio/video data playing application. A car A/V system head unit can play music files as well as videos and movies, and can also work with a GPS navigation system.

However, in recent years, car accidents happened frequently due to watching a display screen during driving. A car driver may ignore the front driving conditions when distracted by watching the car display. In view of this problem, most countries apply strict regulations to define the use of a display screen in a car. These regulations allow a car drive to use a vehicle GPS navigation system, however, they prohibit a car driver from watching videos during driving. Due to the application of strict traffic regulations regarding the use of a car display screen, the application of a car A/V system head unit is relatively affected.

In recent years, due to continuous improvement of wireless communication technology, smart phone, tablet computer and many other wireless communication devices can be linked to a car A/V system main unit (for example, Taiwan Utility Model No. M434400, issued to the present inventor, entitled “Car A/V playback system capable of linking a mobile device”. This car A/V system main unit enables a text message (brief message) received from a smart phone, tablet computer or mobile computer to be displayed on the display screen thereof.

However, it is dangerous to watch a brief message, community message or other text message that is displayed on the display screen of a car A/V system head unit when one is driving a car. Further, the text message is usually too small to be convenient read out, the driver barely view the message content will increase the risks of distracted driving.

### SUMMARY OF THE INVENTION

The present invention has been accomplished under the circumstances in view. It is one object of the present invention to provide a car A/V system with text message voice output function, which converts every received text message into a voice signal for output when the user is driving the car, avoiding distracted driving, enhancing driver safety and complying to relevant transport regulations.

To achieve this and other objects of the present invention, a car A/V system with text message voice output function comprises a text message receiving and decoding device for receiving a text message sent by an external communication device and decoding the text message into a decoded data signal, a display device including a display zone for display the decoded data signal and function selection touch zones selectively touchable by a person to select different functions, a text/voice converter for converting the decoded data signal into a voice signal, and a voice output system for outputting the voice signal. Thus, the car A/V system head unit can convert each received text message into a voice signal and output the voice signal directly in the car, avoiding distracted driving and enhancing driver safety.

Further, the text/voice converter comprises at least one voice table for converting the decoded data signal into a digital voice signal, a reading device electrically connected to the at least one voice table and adapted to read in the digital voice signal, and a digital/analog converter electrically connected to the reading device and adapted to convert the digital voice signal into an analog voice signal for output.

Further, the display device comprises a first function selection touch zone clickable to read out the text message by voice, a second function selection touch zone clickable to temporarily store the text message for reading at a later time, a third function selection touch zone clickable to stop reading out the text message, and a fourth function selection touch zone clickable to reply to the text message.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating the system architecture of a car A/V system with text message voice output function in accordance with the present invention.

FIG. 2 is a system block diagram of the car A/V system with text message voice output function in accordance with the present invention.

FIG. 3 is a schematic drawing illustrating the architecture of the text/voice converter shown in FIG. 2.

FIG. 4 is a system block diagram of the CPU, voice output system, speaker and front face panel of the car A/V system head unit in accordance with the present invention.

FIG. 5 is a schematic applied view of the present invention, illustrating the car A/V system head unit installed in a car center console.

### DETAILED DESCRIPTION OF THE PREFERRED EMBODIMENT

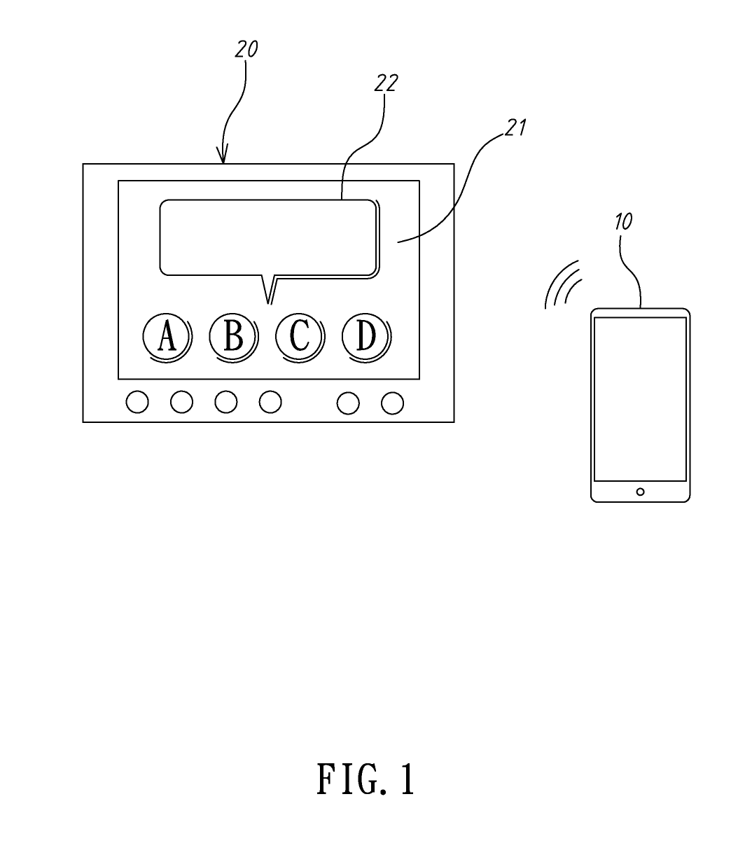

Referring to FIG. 1, a car A/V system with text message voice output function in accordance with the present invention is shown comprising a head unit 20 having built therein a display screen 21 (that can be, for example, a touchscreen). When the head unit 20 received a text message 22 sent wirelessly by a wireless communication device, for example, smart phone 10, a signal (for example, the word of “NEW MESSAGE” will be displayed on the display screen 21. At this time, the driver can selectively click on the touch zones A;B;C;D of the display screen 21, for example, clicking on touch zone A to read out the text message 22 by voice, touch zone B to temporarily store the text message 22 for reading at a later time, touch zone C not to read out the text message 22, or touch zone D to reply to the text message 22.

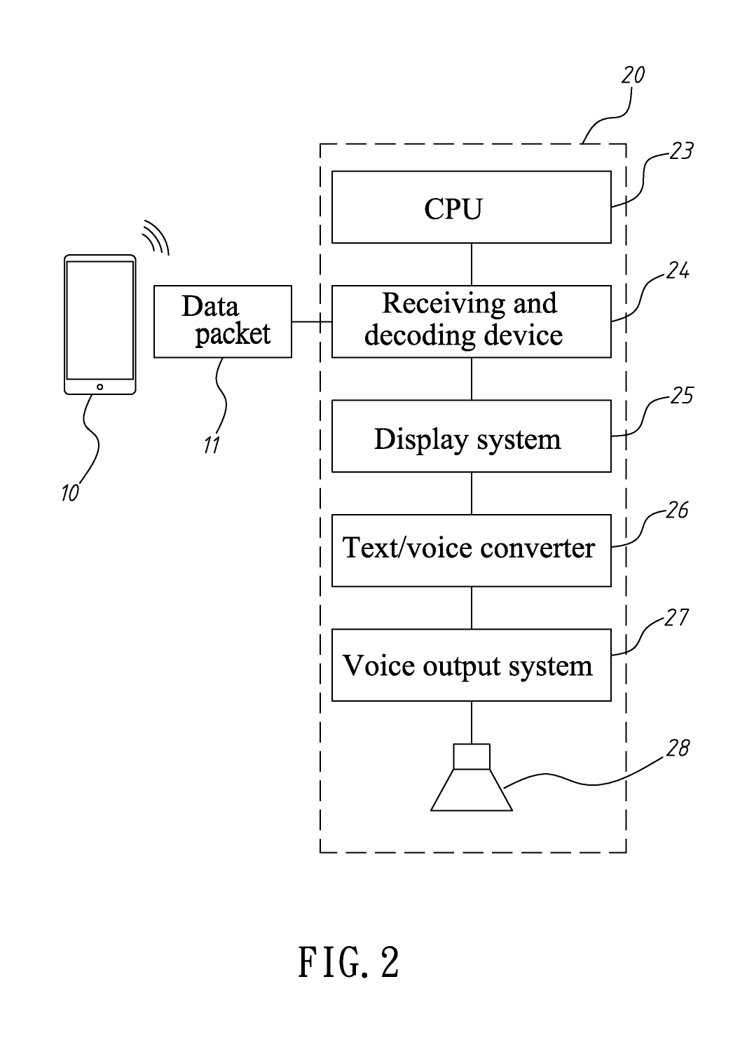

Referring to FIG. 2, the car A/V system head unit 20 comprises a central processing unit (CPU) 23, a receiving and decoding device 24 electrically connected to the CPU 23 and adapted to receive and decode a data packet 11 of a text message sent wirelessly by a smart phone 10 or any other wireless communication device, a display system 25 electrically connected to the CPU 23 and controlled by the CPU 23 to display the decoded data packet 11, a text/voice converter 26 electrically connected to the CPU 23 and controlled by the CPU 23 to convert the decoded data packet 11 into a voice signal, a speaker 28 for voice output, and a voice output system 27 electrically connected to the CPU 23 and controlled by the CPU 23 to output the converted voice signal through the speaker 28.

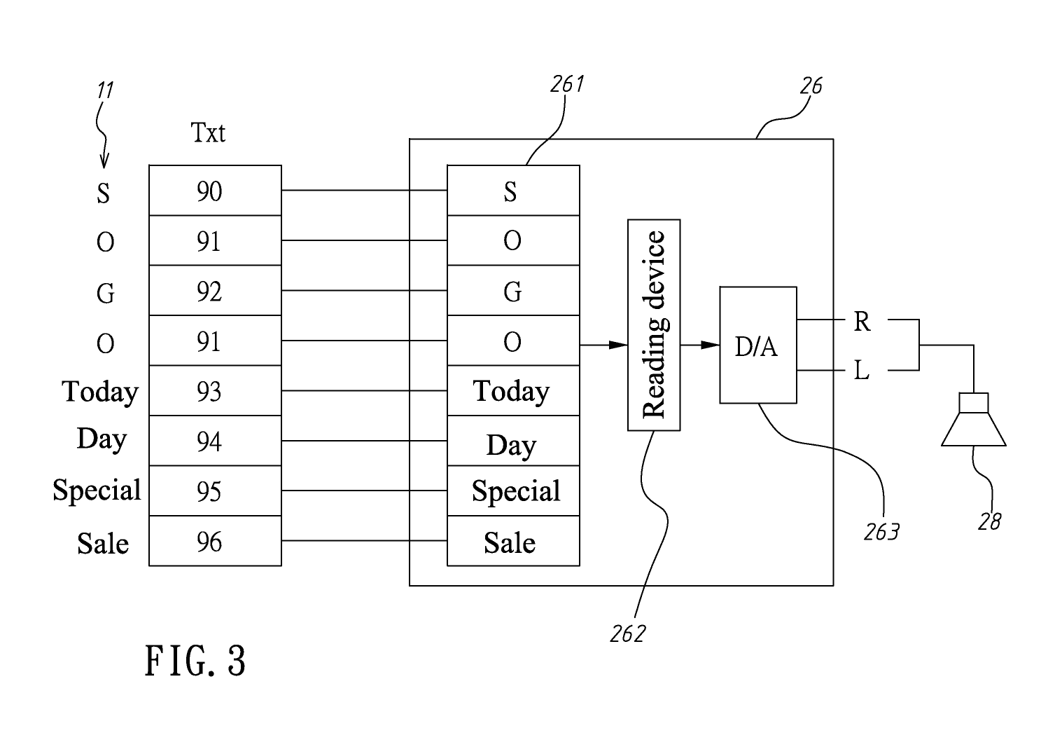

Referring to FIG. 3, the aforesaid text/voice converter 26 matches the data packet 11 of the text message encoded subject to ASCII (American Standard Code for Information Interchange) with a built-in voice table and then outputs the matched data. As illustrated, the data packet 11 of the text message contains the letter combination of “S”, “O”, “G”, “O”, “ [symbol] (today)”, “ [symbol] (day)”, “ [symbol] (special)”, “ [symbol] (sale)”, wherein each letter represents a respective code in ASCII, for example, 90 through 96 specified in the drawing, for example, “S” represents the code “90” in ASCII, “O” represents the code “91” in ASCII, . . . , and so on. The aforesaid text/voice converter 26 comprises at least one voice table 261 for converting the encoded data packet into a digital voice signal, a reading device 262 adapted to read in the digital voice signal, and a digital/analog converter 263 adapted to convert the digital voice signal from the reading device 262 into an analog voice signal for output by the voice output system 27 through the speaker 28.

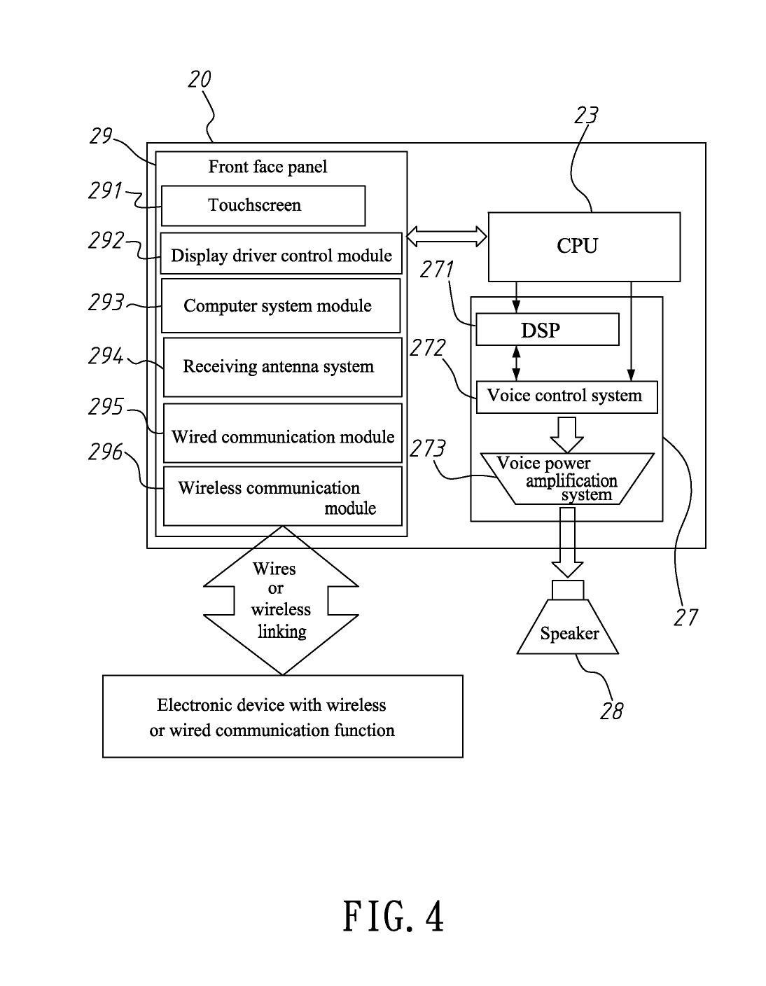

Referring to FIG. 4, the voice output system 27 is controlled by the CPU 23 of the car A/V system head unit 20, comprising a DSP (Digital Signal Processor) 271 for processing digital voice signals, a voice control system 272, and a voice power amplification system 273. Further, the CPU 23 is electrically connected to a front face panel 29 of the car A/V system head unit 20. The front face panel 29 comprises a touchscreen 291, a display driver control module 292, a computer system module 293, a built-in receiving antenna system 294, a wired communication module 295, and a wireless communication module 296. Subject to the configuration of the front face panel 29, the car A/V system head unit 20 can receive a text message sent by a wired or wireless electronic device, and then displays the text message on the display screen 21, or converts the text message into a voice message for output subject to the driver's choice.

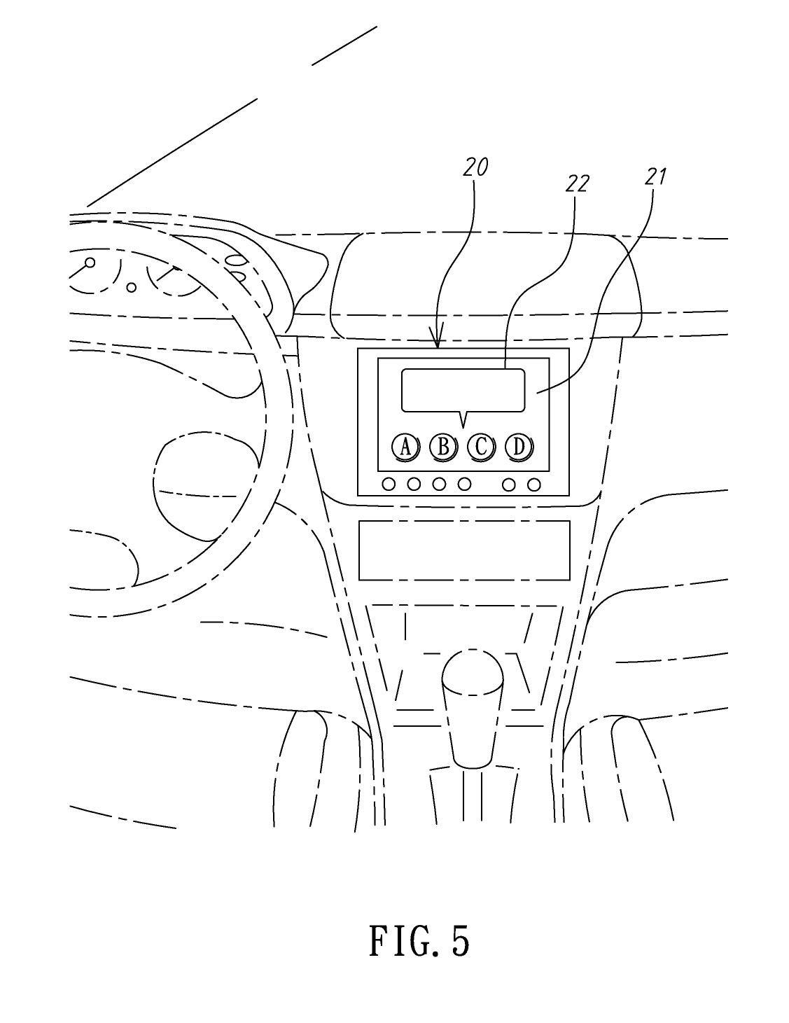

Referring to FIG. 5, after installation of the car A/V system head unit 20 in a car, the car A/V system head unit 20 can receive a text message 22 sent by a wired communication device or wireless communication device. Upon receipt of a text message 22 by the car A/V system head unit 20, the driver can selectively click on one of the touch zones A;B;C;D of the display screen 21 to read out the text message 22 by voice, to temporarily store the text message 22, or to reply to the text message 22 after heard the voice content of the text message 22.

Further, the car A/V system head unit 20 can be configured to pick up and record the driver's voice by means of a microphone (not shown), and then to convert the voice data into a text data by means of a voice sound spectrum identification database and text library (not shown). At this time, the driver can operate the front face panel 29 of the car A/V system head unit 20 to play back the text data by voice for confirmation, and then to transmit the text data to the wirelessly linked smart phone.

The car A/V system head unit enables the driver of the car to know the content of a received text message without viewing the text message, avoiding distracted driving and enhancing driver safety.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A car A/V system head unit, comprising:
a text message receiving and decoding device adapted to receive a text message sent by an external communication device and to decode said text message into a decoded data signal;
display device comprising a display zone adapted to display said decoded data signal, and a plurality of function selection touch zones selectively touchable by a person to select different functions;
a text/voice converter adapted to convert said decoded data signal into a voice signal; and
a voice output system adapted to output said voice signal.

2. The car A/V system head unit as claimed in claim 1, wherein said text/voice converter comprises at least one voice table for converting said decoded data signal into a digital voice signal, a reading device electrically connected to said at least one voice table and adapted to read in said digital voice signal, and a digital/analog converter electrically connected to said reading device and adapted to convert said digital voice signal into an analog voice signal for output.

3. The car A/V system head unit as claimed in claim 1, wherein said display device comprises a first function selection touch zone clickable to read out said text message by voice, a second function selection touch zone clickable to temporarily store said text message for reading at a later time, and a third function selection touch zone clickable to stop reading out said text message.

4. The car A/V system head unit as claimed in claim 3, wherein said display device further comprises a fourth function selection touch zone clickable to reply to said text message.
